(19) United States
(12) Patent Application Publication
(10) Pub. No.: US 2011/0213897 A1
(43) Pub. Date: Sep. 1, 2011

(54) SYSTEMS AND METHODS FOR RELEASING STALE CONNECTION CONTEXTS

(75) Inventors: Suli Zhao, San Diego, CA (US); Srinivasan Balasubramanian, San Diego, CA (US); Ajith T. Payyappilly, San Diego, CA (US)

(73) Assignee: QUALCOMM Incorporated, San Diego, CA (US)

(21) Appl. No.: 13/023,736

(22) Filed: Feb. 9, 2011

Related U.S. Application Data
(60) Provisional application No. 61/308,645, filed on Feb. 26, 2010.

(51) Int. Cl. G06F 15/16

(52) U.S. Cl. 709/248

(57) ABSTRACT

Systems and methods for releasing stale connection contexts are provided herein. The systems and methods help to ensure that connection records between mobile devices and communications nodes are synchronized so as to avoid and/or fix stale connection contexts.

### CROSS REFERENCE TO RELATED APPLICATION(S)

This application claims the benefit of U.S. Provisional Application No. 61/308,645, filed Feb. 26, 2010, the entire content of which is incorporated herein by reference.

### BACKGROUND

1. Field

The present application relates generally to communications, and more specifically to systems and methods for releasing stale connection contexts between a mobile device and a network access node in a communication network.

2. Background

Wireless communication systems are widely deployed to provide various types of communication (e.g., voice, data, multimedia services, etc.) to multiple users. Further, such communications may be provided by a variety of sources. Users of mobile devices may run applications that receive communications from these various sources. In order to communicate data for the multiple applications with these various sources, a mobile device may communicate over several different wireless connections with an access node of a communication network.

Each connection encompasses a set of information that is referred to as the connection context. Such information may include an identifier of the user(s) of the connection, the state of the connection, etc. The access node and mobile device may each store records of the connection contexts for the connections they communicate over.

In some cases, the records of the connection contexts of the connections between the access node and the mobile device may be different at the access node and the mobile device due to some error. Accordingly, one device may have a record of a connection context while the other device does not have a record of the connection context. This may be referred to as a “stale” connection context. It is desirable to delete or “release” such stale connection contexts in order to make sure the records of the connection context are the same or “synchronized” between the mobile device and the access node.

### SUMMARY

The systems, methods, and devices of the invention each have several aspects, no single one of which is solely responsible for its desirable attributes. Without limiting the scope of this invention as expressed by the claims which follow, some features will now be discussed briefly. After considering this discussion, and particularly after reading the section entitled “Detailed Description” one will understand how the features of this invention provide advantages that include systems and method for releasing stale connection contexts.

One embodiment of the disclosure provides a method for releasing a stale connection context. The method comprises receiving a request to terminate a stale connection context with a first device. The method further comprises transmitting an acknowledgement message to the first device.

Another embodiment of the disclosure provides a method for releasing a stale connection context. The method comprises determining a communication service is available from a communication node. The method further comprises transmitting a test message to the communication node using a connection context. The test message is configured to trigger the communication node to perform a resynchronization procedure when the connection context is stale at the communication node.

Yet another embodiment of the disclosure provides a method for releasing a stale connection context. The method comprises receiving data related to a connection context from a first device. The method further comprises determining, based on reception of the data, that the connection context is stale. The method further comprises performing a resynchronization procedure with the first device.

Yet another embodiment of the disclosure provides a method for releasing a stale connection context. The method comprises receiving a request for a first connection context with a device. The method further comprises determining there is a second connection context with the device that conflicts with the requested first connection context. The method further comprises performing a resynchronization procedure with the device.

Yet another embodiment of the disclosure provides a communication apparatus. The communication apparatus comprises a receiver configured to receive data related to a connection context from a first device. The communication apparatus further comprises a processor. The processor is configured to determine, based on reception of the data, that the connection context is stale. The processor is further configured to perform a resynchronization procedure with the first device.

Yet another embodiment of the disclosure provides a communication apparatus. The communication apparatus comprises a receiver configured to receive a request for a first connection context with a device. The communication apparatus further comprises a processor. The processor is configured to determine that there is a second connection context with the device that conflicts with the requested first connection context. The processor is further configured to perform a resynchronization procedure with the device.

Yet another embodiment of the disclosure provides a computer program product comprising a computer-readable medium. The computer-readable medium comprises code for causing a computer to receive data related to a connection context from a first device. The computer-readable medium further comprises code for causing a computer to determine, based on reception of the data, that the connection context is stale. The computer-readable medium further comprises code for causing a computer to perform a resynchronization procedure with the first device.

Yet another embodiment of the disclosure provides a computer program product comprising a computer-readable medium. The computer-readable medium comprises code for causing a computer to receive a request for a first connection context with a device. The computer-readable medium further comprises code for causing a computer to determine there is a second connection context with the device that conflicts with the requested first connection context. The computer-readable medium further comprises code for causing a computer to perform a resynchronization procedure with the device.

Yet another embodiment of the disclosure provides a communication apparatus. The communication apparatus comprises means for receiving data related to a connection context from a first device. The communication apparatus further comprises means for determining, based on reception of the data, that the connection context is stale. The communication apparatus further comprises means for performing a resynchronization procedure with the first device.

Yet another embodiment of the disclosure provides a communication apparatus. The communication apparatus comprises means for receiving a request for a first connection context with a device. The communication apparatus further comprises means for determining there is a second connection context with the device that conflicts with the requested first connection context. The communication apparatus further comprises means for performing a resynchronization procedure with the device.

### BRIEF DESCRIPTION OF THE DRAWINGS

FIG. 1 illustrates an exemplary wireless communication network.

FIG. 2 is a functional block diagram of certain communication devices of the communication network of FIG. 1.

FIG. 3 is an exemplary signal flow diagram illustrating signal flow for setting up a connection context between a user equipment (UE) and an application server of FIG. 2.

FIG. 4 is an exemplary signal flow diagram illustrating signal flow for deleting a connection context between a user equipment (UE) and an application server of FIG. 2.

FIG. 5 is another exemplary signal flow diagram illustrating signal flow for deleting a connection context between a user equipment (UE) and an application server of FIG. 2.

FIG. 6 is a flowchart of an exemplary process for preventing a stale connection between a UE and a High Rate Packet Data (HRPD) Serving Gateway (HSGW) of FIG. 2.

FIG. 7 is a flowchart of an exemplary process for fixing a stale connection between a user equipment (UE) and a High Rate Packet Data (HRPD) Serving Gateway (HSGW) of FIG. 2.

FIG. 8 is a flowchart of another exemplary process for fixing a stale connection between a user equipment (UE) and a High Rate Packet Data (HRPD) Serving Gateway (HSGW) of FIG. 2.

FIG. 9 is a flowchart of yet another exemplary process for fixing a stale connection between a user equipment (UE) and a High Rate Packet Data (HRPD) Serving Gateway (HSGW) of FIG. 2.

FIG. 10 is a functional block diagram of an exemplary a user equipment (UE) shown in FIG. 2.

FIG. 11 is a functional block diagram of an exemplary High Rate Packet Data (HRPD) Serving Gateway (HSGW) shown in FIG. 2.

### DETAILED DESCRIPTION

The word “exemplary” is used herein to mean “serving as an example, instance, or illustration.” Any embodiment described herein as “exemplary” is not necessarily to be construed as preferred or advantageous over other embodiments. The following description is presented to enable any person skilled in the art to make and use the invention. Details are set forth in the following description for purpose of explanation. It should be appreciated that one of ordinary skill in the art would realize that the invention may be practiced without the use of these specific details. In other instances, well known structures and processes are not elaborated in order not to obscure the description of the invention with unnecessary details. Thus, the present invention is not intended to be limited by the embodiments shown, but is to be accorded with the widest scope consistent with the principles and features disclosed herein.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM”, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS and LTE are described in documents from an organization named “3rd Generation Partnership Project” (3GPP). cdma2000 is described in documents from an organization named “3rd Generation Partnership Project 2” (3GPP2). These various radio technologies and standards are known in the art.

Single carrier frequency division multiple access (SC-FDMA), which utilizes single carrier modulation and frequency domain equalization is a technique. SC-FDMA has similar performance and essentially the same overall complexity as those of OFDMA system. SC-FDMA signal has lower peak-to-average power ratio (PAPR) because of its inherent single carrier structure. SC-FDMA has drawn great attention, especially in the uplink communications where lower PAPR greatly benefits the mobile terminal in terms of transmit power efficiency. It is currently a working assumption for uplink multiple access scheme in 3GPP Long Term Evolution (LTE), or Evolved UTRA.

Furthermore, in the following description, for reasons of conciseness and clarity, terminology associated with the Evolved High Rate Packet Data (eHRPD) air interface used to access the core network architecture defined in 3GPP TS 23.401 and TS 23.402 and promulgated under the 3rd Generation Partnership Project 2 (3GPP2) is referenced. The eHRPD technology is further described in “E-UTRAN-eHRPD Connectivity and Interworking: Core Network Aspects: 3GPP2 X.S0057-0 v1.8,” dated Sep. 24, 2009, which is hereby incorporated by reference in its entirety. The eHRPD systems may be compatible It should be emphasized that the invention may also be applicable to other technologies, such as technologies and the associated standards related to Wideband Code Division Multiple Access (WCDMA), Time Division Multiple Access (TDMA), Orthogonal Frequency Division Multiple Access (OFDMA), LTE and so forth. Terminologies associated with different technologies can vary. For example, depending on the technology considered, the User Equipment (UE) used in eHRPD can sometimes be called a mobile station, a user terminal, a subscriber unit, an access terminal, etc., to name just a few. Likewise, the HRPD Serving Gateway (HSGW) used in eHRPD can sometimes be called a gateway, a serving gateway, and so forth. Likewise, the Evolved Access Network (eAN) used in eHRPD can sometimes be called an access network (AN), a packet control function (PCF), and so forth. Likewise, the HRPD base station (BTS) used in eHRPD can sometimes be called an access node, an access point, a base station, a Node B, and so forth. It should be noted here that varying terminologies apply to different technologies when applicable.

A UE may form multiple connections (e.g., packed data network (PDN) connections) with an HSGW to access various application servers running on a communication network. Each of these connections may have a corresponding connection context (e.g., PDN context), which is stored on both the UE and the HSGW. In some instances, the UE and the HSGW may have mismatching records of the connections contexts. For example, the UE might have a record of a connection context that the HSGW does not, or vice versa. Such a connection context is referred to as a “stale” connection context. Accordingly, due to a stale connection context at one end or the other, one of the UE or the HSGW may be configured to use a connection that the other is not configured to use, leading to communication errors. The systems and methods described herein help resolve such inconsistencies by releasing stale connection contexts.

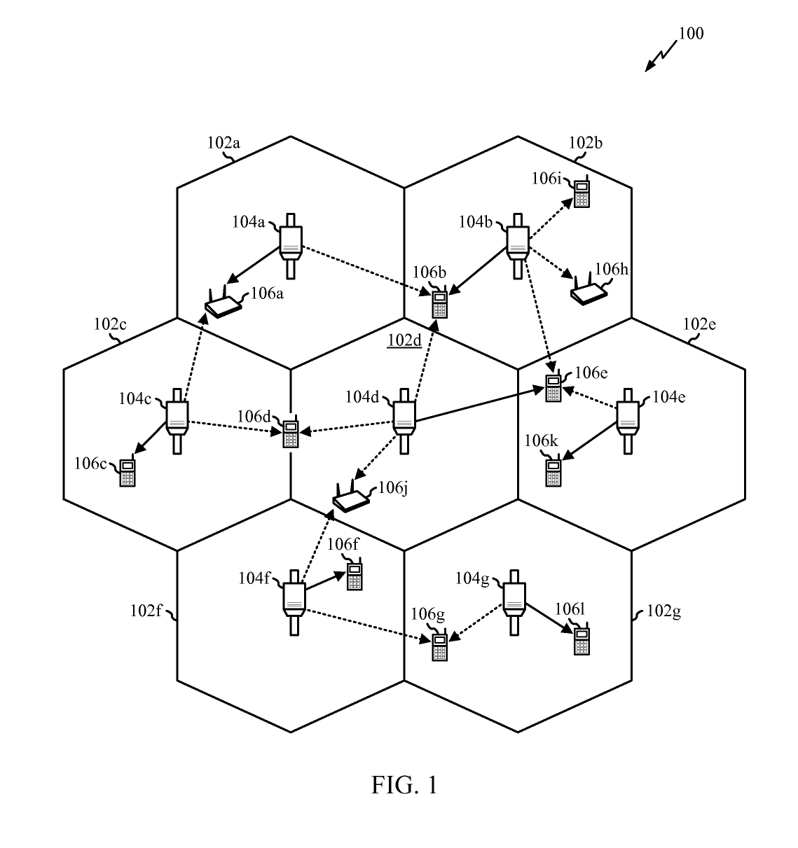

FIG. 1 illustrates an exemplary wireless communication network 100. The wireless communication network 100 is configured to support communication between a number of users. The wireless communication network 100 may be divided into one or more cells 102, such as, for example, cells 102a-102g. Communication coverage in cells 102a-102g may be provided by one or more BTSs 104, such as, for example, BTSs 104a-104g. Each BTS 104 may provide communication coverage to a corresponding cell 102. The BTSs 104 may interact with a plurality of UEs, such as, for example, UEs 106a-106l.

Each UE 106 may communicate with one or more BTSs 104 on a forward link (FL) and/or a reverse link (RL) at a given moment. A FL is a communication link from a BTS to an UE. A RL is a communication link from an UE to a BTS. The FL may also be referred to as the downlink. Further, the RL may also be referred to as the uplink. The BTSs 104 may be interconnected, for example, by appropriate wired or wireless interfaces and may be able to communicate with each other. Accordingly, each UE 106 may communicate with another UE 106 through one or more BTSs 104.

The wireless communication network 100 may provide service over a large geographic region. For example, the cells 102a-102g may cover only a few blocks within a neighborhood or several square miles in a rural environment. In one embodiment, each cell may be further divided into one or more sectors (not shown).

As described above, a BTS 104 may provide UE 106 access within its coverage area to another communications network, such as, for example the internet or another cellular network.

An UE 106 may be a wireless communication device (e.g., a mobile phone, router, personal computer, server, etc.) used by a user to send and receive voice or data over a communications network. As shown, UEs 106a, 106h, and 106j comprise routers. UEs 106b-106g, 106i, 106k, and 106l comprise mobile phones. However, each of UEs 106a-106l may comprise any suitable communication device.

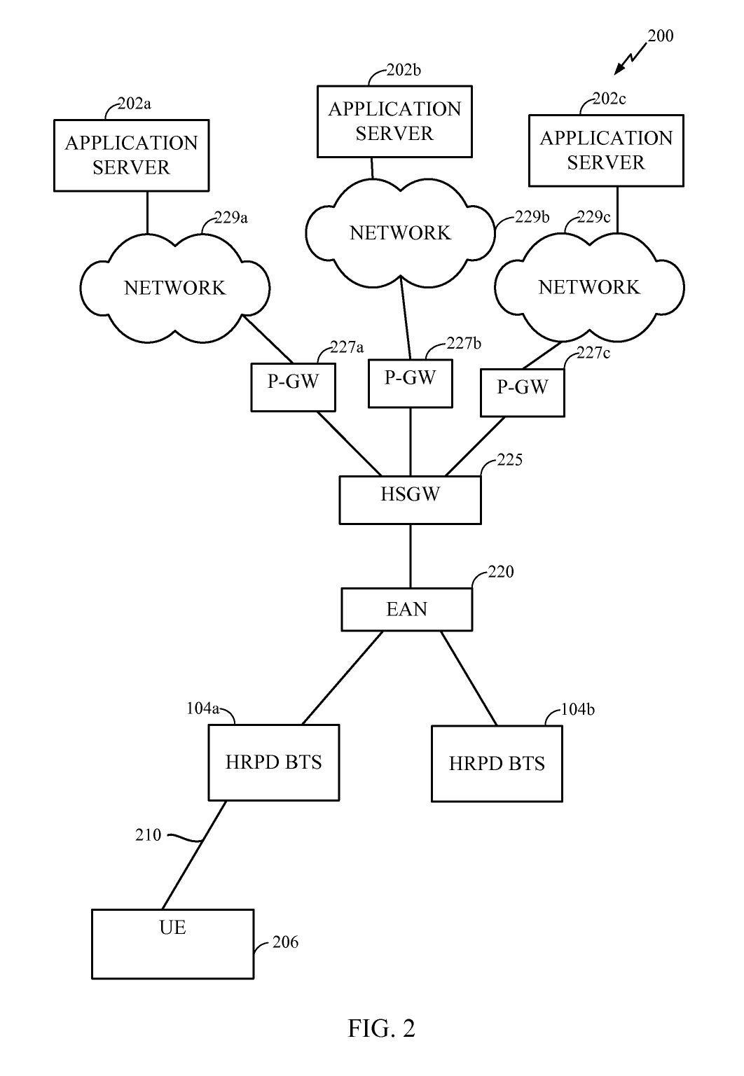

FIG. 2 is a functional block diagram of certain communication devices of the communication network of FIG. 1. It may be desirable for an UE 206 (which may be similar to a UE 106a discussed above) to receive data (e.g., data packets for a web browsing session, data packets for a Voice Over IP (VoIP) call, data packets for a video stream, or other data or media content) from one or more data sources such as application servers 202a, 202b, 202c (e.g., a server controlled by a content provider, such as, internet websites provided by CNN®, YAHOO!®, etc.). FIG. 2 illustrates an exemplary embodiment in which the UE 206 may communicate with the application servers 202a-202c to receive information.

The UE 206 may send a request seeking data from the application server 202a to the BTS 104a. The UE 206 may establish a communication link with the BTS 104a. The communication link 210 may be an appropriate wireless link, such as, an airlink. The UE 206 may send the request to the BTS 104a via the communication link 210.

The BTS 104a may receive from the UE 206 the request seeking data from the application server 202a. The BTS 104a may facilitate communication between the UE 206 and the application server 202a by sending the request for data to an eAN 220. The BTS 104a and the eAN 220 may be coupled by one or more appropriate wired links (e.g., fiber optic cable, copper cable, etc.) and/or wireless links (e.g., airlinks). The eAN 220 may further be configured to control functions of the BTS 104a. The eAN 220 may forward the request to an appropriate HSGW 225. The eAN 220 and the HSGW 225 may be coupled by one or more appropriate wired links (e.g., fiber optic cable, copper cable, etc.) and/or wireless links (e.g., airlinks). The eAN 220 may further communicate with one or more additional BTSs (e.g., BTS 104b) via one or more additional wired links.

The HSGW 225 may receive from the eAN 220 the sent request seeking data from the application server 202a. The HSGW 225 may facilitate communication between the UE 206 and the application server 202a by sending the request for data to the appropriate gateway (e.g., PDN gateway (P-GW) 227a).

The HSGW 225 may be coupled to one or more P-GWs 227a, 227b, 227c by one or more appropriate wired links (e.g., fiber optic cable, copper cable, etc.) and/or wireless links (e.g., airlinks). Each P-GW 227a, 227b, 227c may be associated with a different network 229a, 229b, 229c (e.g., PDN network). The P-GW 227a, 227b, 227c may access devices in the associated networks 229a, 229b, 229c, respectively, via one or more appropriate wired (e.g., fiber optic cable, copper cable, etc.) or wireless links (e.g., airlink). For example, each network 229a, 229b, 229c may have an application server 202a, 202b, 202c, respectively as part of the network 229a, 229b, 229c. Further, each network 229a, 229b, 229c may have associated with it an access point name (APN), unique to each network. Each P-GW 227a-227c may be directly coupled to its respective server 202a-202c or may be indirectly connected through another device. Accordingly, the HSGW 225 may determine which P-GW 227a-227c to send the request for data to, based on the destination of the request. For example, the HSGW 225 sends the request seeking data from the application server 202a to the P-GW 227a, so that the request reaches the application server 202a. The P-GW 227a then sends the request to the application server 202a via the network 229a.

The network 229a may receive from the P-GW 227a the request seeking data from the application server 202a. The network 229a may facilitate communication between the UE 206 and the application server 202a by sending the request for data to the application server 202a via an appropriate wired or wireless link. The network 229a may comprise, for example, an intranet or a part of the Internet. In one embodiment, the network 229a operates pursuant to the internet protocol (IP) as promulgated by the Internet Engineering Task Force (IETF). The network may be in communication with one or more additional application servers (not shown).

The application server 202a may receive from the network 229a the request for data. The application server 202a may comprise a server connected to the network 229a. The application server 202a may serve data content such as video streams to devices that access the network 229a. The UE 206 may access the application server 202a to retrieve video streams or other data as described above. Accordingly, the application server 202 may process the received request and transmit the requested data to the UE 206 via the network 229a, the P-GW 227a, the HSGW 225, the eAN 220, and the BTS 104a.

In eHRPD, for the UE 206 to communicate with the application server 202a, the UE 206 may need to setup a PDN connection with the application server 202a. The UE 206 may setup a PDN connection with each data source that the UE 206 communicates. The PDN connection may be a logical connection between the application server 202a and the UE 206 that corresponds to one or more physical connections required for the UE 206 and the application server 202a to communicate.

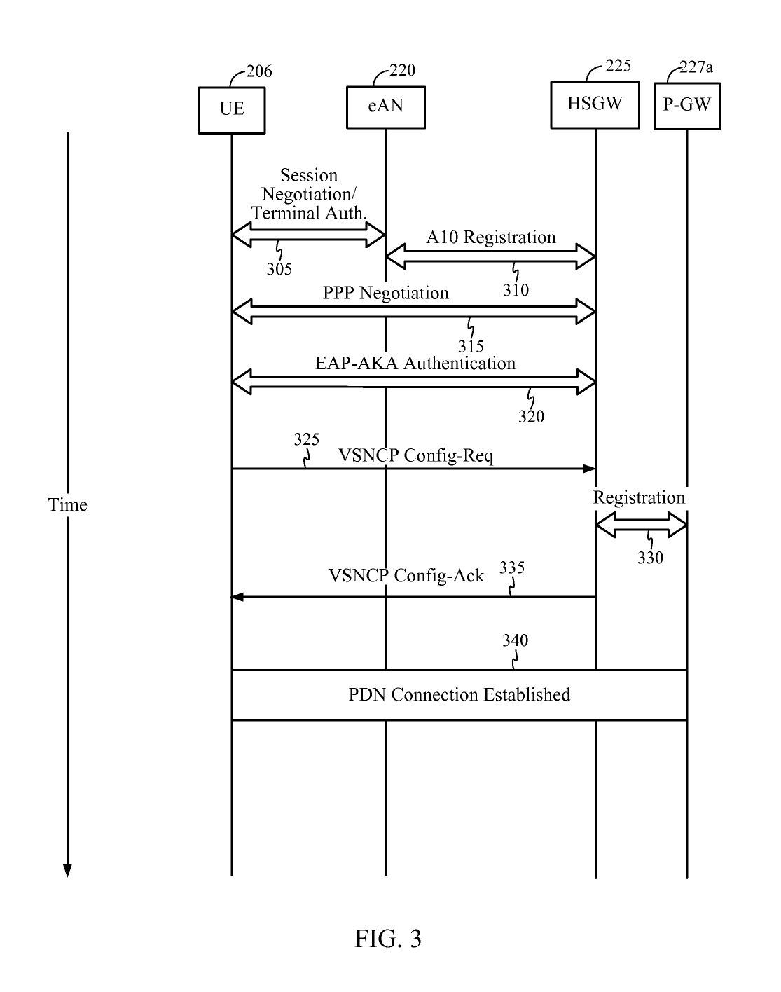

FIG. 3 is an exemplary signal flow diagram illustrating signal flow for setting up a connection context between a user equipment (UE) and an application server of FIG. 2. The UE 206, the eAN 220, the HSGW 225, and the P-GW 227a are shown horizontally at the top of the figure. The flow of various signals or data packets communicated between apparatuses is shown with directional arrows. The sequence of flow of signals occurs as time progresses. The progression of time is shown along the vertical axis of FIG. 3, with time starting at the top of the page and progressing down the page.

First, the UE establishes a communication link with the HSGW 225. At 305, the UE 206 exchanges signals with the eAN 220 to establish a communication session (e.g., an eHRPD session) with each other. The UE 206 may exchange signals with the eAN 220 via the BTS 104a. Accordingly, the UE 206 negotiates a communication session/authorizes itself with the eAN 220. Further, at 310, the eAN 220 exchanges signals with the HSGW 225 to establish at least one link (e.g., an A10 connection) configured to carry data packets. Accordingly, the eAN 220 registers a link with the HSGW 225. Thus, a communication link is established between the UE 206 and the HSGW 225.

At 315, when an application is started on the UE 206 that transmits/receives data with a data source (e.g., application server 202a), the UE 206 triggers negotiation and establishment of a point-to-point protocol (PPP) link with the HSGW 225 if a PPP is not already established. Accordingly, the UE 206 and the HSGW 225 perform link control protocol (LCP) negotiation and select extensible authentication protocol (EAP) as the authentication protocol.

Continuing at 320, the UE 206 and the HSGW 225 use an Extensible Authentication Protocol Method for UMTS Authentication and Key Agreement (EAP-AKA) to authenticate the PPP link. At 320, the HSGW 225 receives from a server on the communication network subscription data containing a list of all of the APNs associated with networks 229a-229c that the UE 206 is permitted to access, an indication about which of those APNs is a default APN for communication, and other information. The HSGW 225 further receives addresses of one or more P-GWs 227a-227c used to access the networks 229a-229c.

Further at 325, the UE 206 sends a vendor specific network control protocol (VSNCP) configuration request (Config-Req) message to the HSGW 225, identifying the data source with which the UE 206 wishes to communicate. The VSNCP Config-Req message includes a PDN-ID, the type of connection, UE network capability information, PDN address, protocol configuration options, attach type information, etc. Continuing at 330, the HSGW 225 selects a P-GW 227a-229a with access to the network 229a-229c containing the data source the UE wants to communicate based on the information provided by the UE 206 in 325 and performs a registration procedure with the selected P-GW 227a-227c. At 335, the HSGW 225 sends a VSNCP configuration acknowledgement (Config-Ack) message to the UE 206 that a connection (e.g., a PDN connection) has been established with the requested data source. Accordingly, at 340, the connection is established.

The UE 206 and the HSGW 225 both store information regarding the created connection, the information being referred to as a connection context (e.g., a PDN context). The connection context is used by the UE 206 and the HSGW 225 to identify and/or route packets (e.g., vendor specific network protocol (VSNP) packets) associated with the connection context over the correct PDN connection so the packets reach the intended party (e.g., the UE 206 and/or a data source). The VSNP packets may have header information included in the packet that identifies the recipient and/or PDN connection to which to transmit the VSNP packet. The PDN context may include information such as a PDN-ID and an APN.

The UE 206 may assign a PDN-ID, which may be a value ranging, for example, from 0-225 to each PDN connection it establishes. The PDN-ID may act as a reference number for the UE 206 and the HSGW 225 to identify a particular PDN context associated with a PDN connection. Since there are a finite number of PDN-IDs, the UE 206 may reuse certain PDN-IDs after releasing a previously established PDN connection associated with that PDN-ID. For example, upon termination of an application on the UE 206, one or more established PDN connections utilized by that application may be released and the PDN contexts deleted from the records of the UE 206 and the HSGW 225. Either the HSGW 225 or the UE 206 may release a PDN connection.

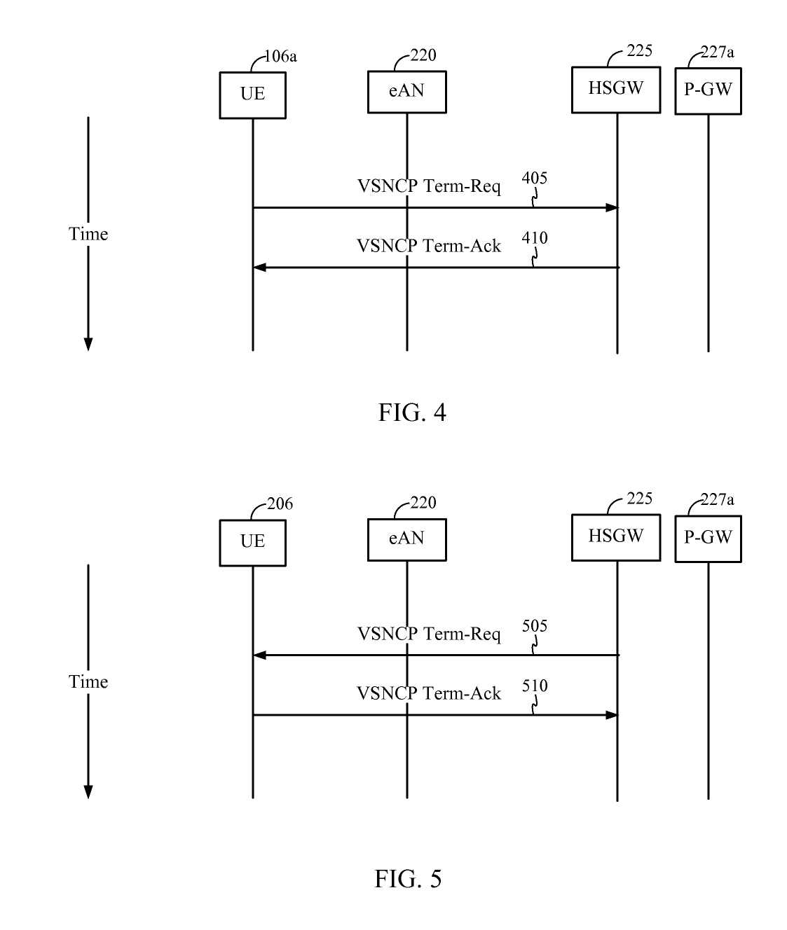

FIG. 4 is an exemplary signal flow diagram illustrating signal flow for deleting a connection context between an user equipment (UE) and an application server of FIG. 2. The UE 206, the eAN 220, the HSGW 225, and the P-GW 227a are shown horizontally at the top of the figure. The flow of various signals or data packets communicated between apparatuses is shown with directional arrows. The sequence of flow of signals occurs as time progresses. The progression of time is shown along the vertical axis of FIG. 4, with time starting at the top of the page and progressing down the page.

Starting at 405, the UE 206 sends a termination message (e.g., a VSNCP termination request (Term-Req) message) requesting release/termination of a PDN connection to the HSGW 225. The message may identify the connection by the PDN-ID. At 410, after the HSGW 225 receives the termination message and successfully identifies and deletes the connection context of the connection, the HSGW 225 sends an acknowledgement message (e.g., a VSNCP termination acknowledgement (Term-Ack) message) to the UE 206. Accordingly, the UE 206 deletes the connection context of the connection. The PDN-ID previously associated with the connection may then be used.

FIG. 5 is another exemplary signal flow diagram illustrating signal flow for deleting a connection context between a user equipment (UE) and an application server of FIG. 2. The UE 206, the eAN 220, the HSGW 225, and the P-GW 227a are shown horizontally at the top of the figure. The flow of various signals or data packets communicated between apparatuses is shown with directional arrows. The sequence of flow of signals occurs as time progresses. The progression of time is shown along the vertical axis of FIG. 5, with time starting at the top of the page and progressing down the page.

Starting at 505, the HSGW 225 sends a termination message (e.g., a VSNCP termination request (Term-Req) message) requesting release/termination of a PDN connection to the UE 206. The message may identify the connection by the PDN-ID. At 510, after the UE 206 receives the termination message and successfully identifies and deletes the connection context of the connection, the UE 206 sends an acknowledgement message (e.g., a VSNCP termination acknowledgement (Term-Ack) message) to the HSGW 225. Accordingly, the HSGW 225 deletes the connection context of the connection. The PDN-ID previously associated with the connection may then be used.

In some cases, an error may occur during the deletion of a connection context procedure between the UE 206 and the HSGW 225. If such an error occurs, either the UE 206 or the HSGW 225 may not release a connection context and delete information related to the connection context, while the other device does release the connection context and delete information related to the connection context. Various reasons may account for one device deleting a connection context and the other device not deleting the connection context. For example, the UE 206 and the HSGW 225 may lose connectivity due to, for example, the UE 206 moving out of a service area of the HSGW 225. Accordingly, either the termination request sent from one device to another may be lost, or the acknowledgment message sent from one device to another may be lost.

For example, the UE 206 may request termination of a connection. The HSGW 225 may not receive the request for termination and therefore does not delete the connection context associated with the connection. Accordingly, the HSGW 225 does not send an acknowledgement that the connection was terminated to the UE 206. The UE 206 may wait for a timeout period and then retransmit the termination request to the HSGW 225. The HSGW 225 may still not receive the request for termination. The UE 206 may retry retransmitting the termination request a finite number of time (e.g., 3) before stopping the retry procedure.

At this point the UE 206 does not have information as to whether the HSGW 225 received the termination request or not. The UE 206 only knows that it did not receive an acknowledgement, which either means the HSGW 225 did not receive the request, or that the HSGW 225 received the request, but the acknowledgment message did not reach the UE 206. Accordingly, the UE 206 may delete the connection context. In the case where the HSGW 225 did not delete the connection context, the HSGW 225 assumes the connection is still active, while the UE 206 assumes the connection has been terminated. The connection held by the HSGW is referred to as a “stale” connection. Similarly, the HSGW 225 may try and terminate a connection and the UE 206 may not receive the termination request and/or the HSGW 225 may not receive the acknowledgment message.

Various errors may occur due to a stale connection held at the UE 206 and/or the HSGW 225. For example, if the UE 206 has deleted a connection, the UE 206 may try and reuse the PDN-ID previously used by that connection by setting up a new connection with the same PDN-ID. Further, the HSGW 225 may still hold the connection context for that connection. Accordingly, the HSGW 225 already has a connection associated with the PDN-ID. When the HSGW 225 receives the request to configure the connection, the HSGW 225 may return an error message to the UE 206 as the PDN-ID is already in use. Similarly, UE 206 may try and create a new connection with an APN for which the HSGW 225 holds a stale connection. The HSGW 225 may similarly return an error message to the UE 206 as the APN is already assigned to another connection.

In another example, if the UE 206 has deleted a connection, the UE 206 may no longer expect data from the HSGW 225 over that connection, such as data from an e-mail server to an e-mail application. The HSGW 225 may still hold the connection context for that connection and try and send data from the e-mail server to the UE 206 over the stale connection. Accordingly, the UE 206 gets unexpected data in error.

In yet another example, if the HSGW 225 has deleted a connection, the HSGW 225 may no longer expect data from the UE 206 over that connection, such as data being uploaded to an application server from the UE 206. The UE 206 may still hold the connection context for that connection and try and send data to the application server via the HSGW 225 over the stale connection. Accordingly, the HSGW 225 gets unexpected data in error.

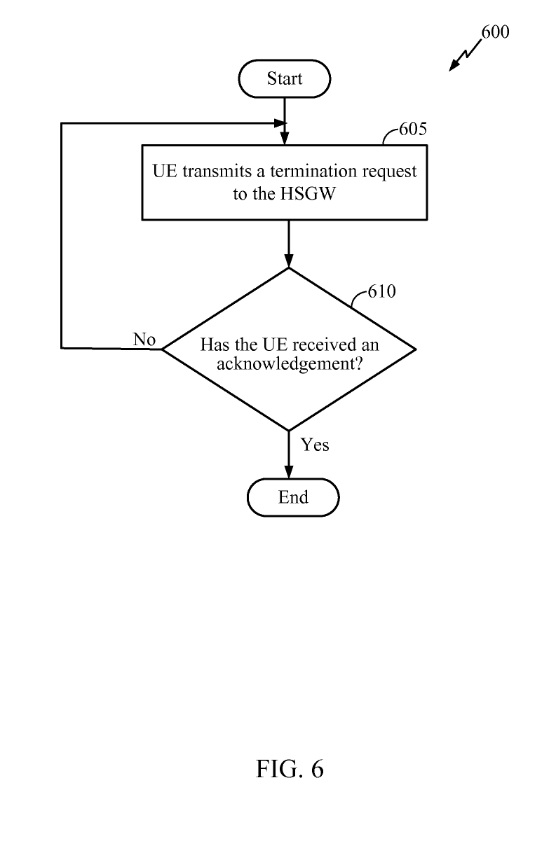

In some embodiments, the UE 206 and the HSGW 225 may be configured to prevent or fix stale connections. FIGS. 6-9 illustrate various processes the UE 206 and/or the HSGW 225 may perform to prevent or fix stale connections.

FIG. 6 is a flowchart of an exemplary process for preventing a stale connection between a UE and a HSGW of FIG. 2. At 605, the UE 206 transmits a termination request to the HSGW 225 to terminate a connection associated with the HSGW 225 and the UE 206. Continuing at 610, the UE 206 determines whether an acknowledgment of the termination request is received from the HSGW 225. If at 610 the UE 206 determines an acknowledgement has been received, the process 600 ends. If at 610, the UE 206 determines an acknowledgement has not been received, the process 600 returns to 605. Accordingly, the UE 206 will continue to send a termination request until an acknowledgement message is received from the HSGW 225. In one embodiment, the UE 206 is configured to only send the termination request when the UE 206 is within a service area of the HSGW 225. Accordingly, a stale connection will not occur, as for the UE 206 to receive an acknowledgement, requires the HSGW 225 to have received the termination request. Accordingly, both the HSGW 225 and the UE 206 successfully terminate the connection.

One potential problem with the process 600 is that the HSGW 225 may receive the termination request and successfully release the connection, delete the connection context, and send an acknowledgment to the UE 206, but the UE 206 may not receive the acknowledgement. Accordingly, in some embodiments, the UE 206 may retry and send the termination request to the HSGW 225. Since the HSGW 225 has already deleted the connection context, the HSGW 225 may not expect the new request, which may cause an error. Accordingly, the HSGW 225 may be configured to release the connection, but retain at least some of the information related to the connection context. If the HSGW 225 receives a request to delete the same connection associated with that connection context, the HSGW 225 resends an acknowledgement to the UE 206 that the connection has been deleted. In another embodiment, the HSGW 225 may delete the connection context information when the UE 206 requests a new connection using the same PDN-ID as the previously deleted connection, as this confirms that the UE 206 has received the acknowledgement and has released the connection and deleted the connection context.

One of ordinary skill in the art should recognize that a similar process to process 600 can be performed where the HSGW 225 sends a termination request to the UE 206. Further, the UE 206 may be configured to resend acknowledgement messages whenever it receives repeat termination requests for the same connection. In one embodiment, the UE 206 is configured to only send the acknowledgement messages when the UE 206 is within a service area of the HSGW 225.

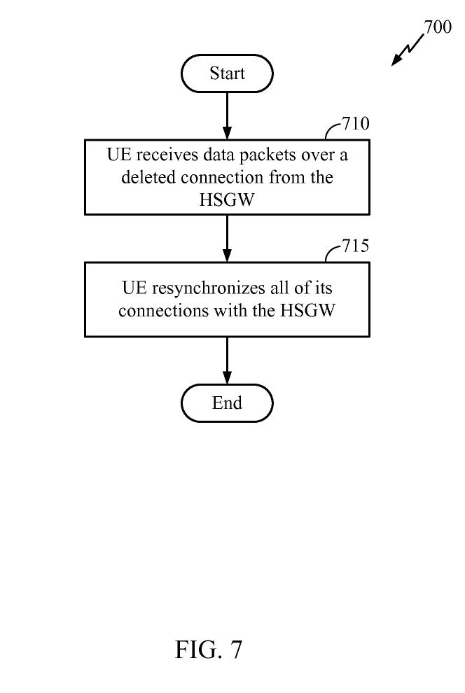

FIG. 7 is a flowchart of an exemplary process for fixing a stale connection between a UE and a HSGW of FIG. 2. At 710, the UE 206 receives data packets related to a connection that the UE 206 has released and deleted the connection context from the HSGW 225. The UE 206, therefore, determines that the HSGW 225 still has information regarding the connection, and therefore has a stale connection. Continuing at 715, the UE 206 resynchronizes all of its connections with the HSGW 225. For example, the UE 206 may start a PPP resynchronization procedure, where the PPP session between the UE 206 and HSGW is terminated and renegotiated/reestablished. The UE 206 then sends VSNCP Config-Req messages for each of the connections it has records of, thereby synchronizing the records of connections between the UE 206 and the HSGW 225.

One of ordinary skill in the art should recognize that a similar process to process 700 can be performed where the HSGW 225 receives data packets related to a connection that the HSGW 225 has released and deleted the connection context from the UE 206.

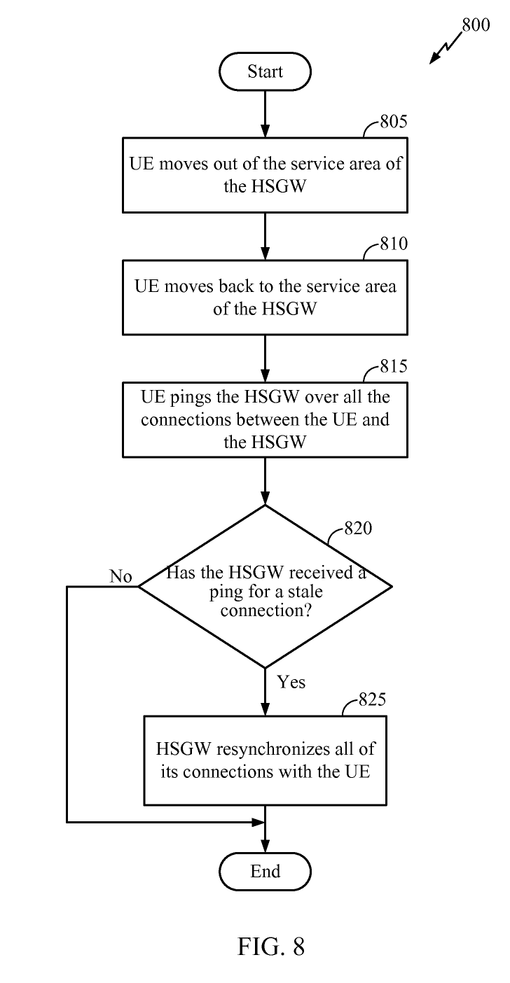

FIG. 8 is a flowchart of another exemplary process for fixing a stale connection between a UE and a HSGW of FIG. 2. As discussed above, the UE 206 may be configured to receive data over a connection from the HSGW 225, such as e-mail data from an e-mail server. Further, the HSGW 225 may have deleted the connection context and released the connection associated with the e-mail server after sending a termination request to the UE 206, while the UE 206 has not received the request and has not terminated the connection. Similarly, the UE 206 may have deleted the connection context and released the connection associated with the e-mail server after sending a termination request to the HSGW 225, while the HSGW 225 has not received the request and has not terminated the connection. Accordingly, the UE 206 or the HSGW 225 may hold a stale connection. In some cases, the HSGW 225 may not receive data to send to the UE 206 over the stale connection for a long period of time. Accordingly, the UE 206 or the HSGW 225 may hold a stale connection for a long period of time without receiving/transmitting data over the stale connection, which the UE 206/HSGW 225 could use to determine the connection is stale.

As discussed above, one reason the devices are not synchronized may be due to the UE 206 leaving the service area while sending/receiving a termination request, such that the termination request is not received by the UE 206 or the HSGW 225. The UE 206 knows when it is within a service area and when it is outside of a service area. For example, the UE 206 may determine whether it has a wireless connection by monitoring whether it has a connection with the BTS 104. The process 800 may utilize this property to help fix stale connections.

At 805 of the process 800, the UE 206 moves out of the service area of the HSGW 225. Continuing at 810, the UE 206 determines it has moved back into the service area of the HSGW 225. Further, at 815, the UE 206 sends one or more pings (e.g., dummy data packets) over each of the connections the UE 206 has a record of with the HSGW 225. Continuing at 820, the HSGW 225 determines if any of the pings are received over a connection for which the HSGW 225 does not have a record. If at 820, the HSGW 225 determines none of the pings are received over a connection for which the HSGW 225 does not have a record, the process 800 ends. If at 820, the HSGW 225 determines at least one of the pings is received over a connection for which the HSGW 225 does not have a record, the process 800 continues to 825. Continuing at 825, the HSGW 225 resynchronizes all of its connections with the UE 206. For example, the HSGW 225 may start a PPP resynchronization procedure, where the PPP session between the UE 206 and HSGW 225 is terminated and renegotiated/reestablished. The HSGW 225 then sends VSNCP Config-Req messages for each of the connections it has records of, thereby synchronizing the records of connections between the UE 206 and the HSGW 225.

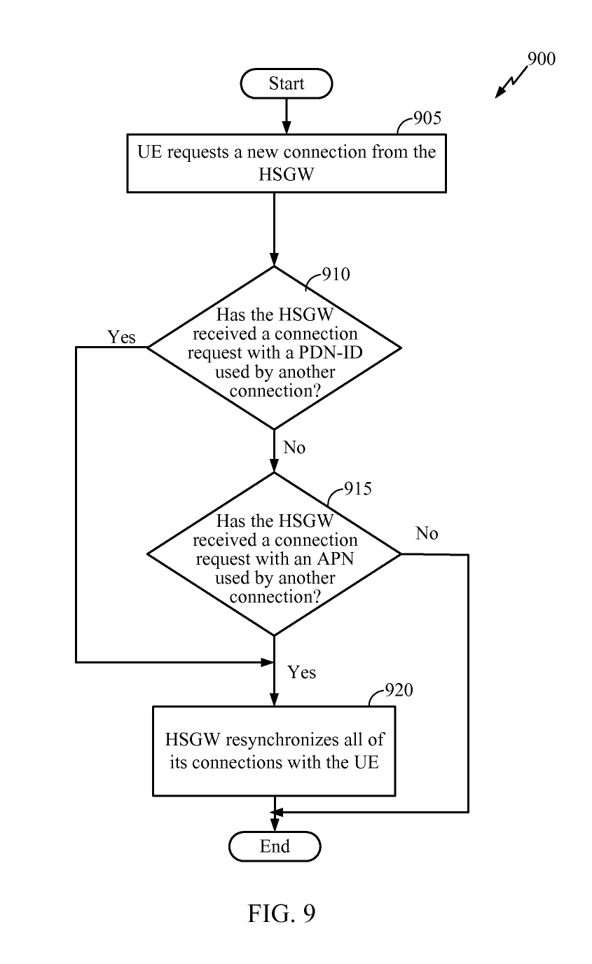

FIG. 9 is a flowchart of yet another exemplary process for fixing a stale connection between a UE and a HSGW of FIG. 2. At 905, the UE 206 requests a new connection. The request may comprise a particular PDN-ID and APN. Continuing at 910, the HSGW 225 determines whether it has a record of a connection with the same PDN-ID. If the HSGW 225 determines it has a record of a connection with the same PDN-ID, the process continues to 920. If the HSGW 225 determines it does not have a record of a connection with the same PDN-ID, the process continues to 915. At 915, the HSGW 225 determines whether it has a record of a connection with the same APN. If the HSGW 225 determines it has a record of a connection with the same APN, the process continues to 920. If the HSGW 225 determines it does not have a record of a connection with the same APN, the process 900 ends.

At 920, either the HSGW 225 or the UE 206 225 resynchronizes all of its connections with the other device. For example, the HSGW 225 may start a PPP resynchronization procedure, where the PPP session between the UE 206 and HSGW 225 is terminated and renegotiated/reestablished. The HSGW 225 then sends VSNCP Config-Req messages for each of the connections it has records of, thereby synchronizing the records of connections between the UE 206 and the HSGW 225.

One of ordinary skill in the art should recognize that for each of processes 600-900, various steps may be added or omitted without departing from the spirit or scope of the invention.

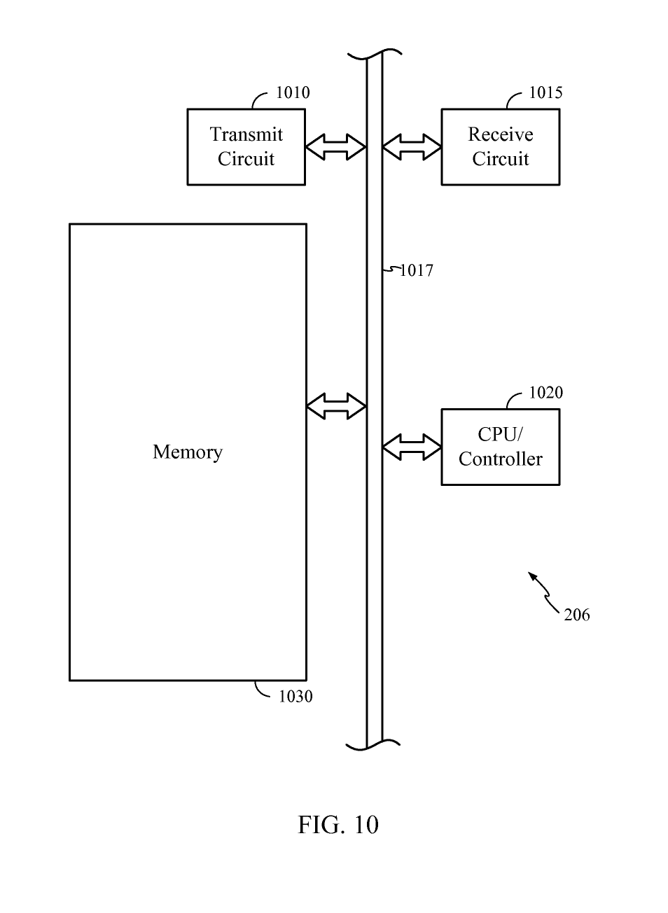

FIG. 10 is a functional block diagram of an exemplary user equipment 206 shown in FIG. 2. As discussed above with respect to FIG. 2, the UE 206 may communicate with the BTS 104a to receive data from the application server 202 by sending a request for data to the application server 202 via the BTS 104a. The UE 206 may comprise a transmit circuit 1010 configured to transmit an outbound message, such as a request for data from the application server 202, to the BTS 104a. The UE 206 may further comprise a receive circuit 1015 configured to receive an incoming message, such as a data packet from the application server 202, from the BTS 104a. The transmit circuit 1010 and the receive circuit 1015 may be coupled to a central processing unit (CPU)/controller 1020 via a bus 1017. The CPU 1020 may be configured to process the inbound and outbound messages coming from or going to the BTS 104a. The CPU 1020 may also be configured to control other components of the UE 206.

The CPU 1020 may further be coupled to a memory 1030 via the bus 1017. The CPU 1020 may read information from or write information to the memory 1030. For example, the memory 1030 may be configured to store inbound or outbound messages before, during, or after processing and/or records of connections and connection contexts. The memory 1030 may also comprise instructions or functions for execution on the CPU 1020. For example, the memory 1030 may comprise instructions or functions to perform the processes and methods described herein.

The transmit circuit 1010 may comprise a modulator configured to modulate outbound message going to the BTS 104a. The receive circuit 1015 may comprise a demodulator configured to demodulate inbound messages coming from the BTS 104a.

The memory 1030 may comprise processor cache, including a multi-level hierarchical cache in which different levels have different capacities and access speeds. The memory 1030 may also comprise random access memory (RAM), other volatile storage devices, or non-volatile storage devices. The storage may include hard drives, optical discs, such as compact discs (CDs) or digital video discs (DVDs), flash memory, floppy discs, magnetic tape, Zip drives, etc.

Although described separately, it is to be appreciated that functional blocks described with respect to the UE 206 need not be separate structural elements. For example, the CPU 1020 and the memory 1030 may be embodied on a single chip. The CPU 1020 may additionally, or in the alternative, contain memory, such as processor registers. Similarly, one or more of the functional blocks or portions of the functionality of various blocks may be embodies on a single chip. Alternatively, the functionality of a particular block may be implemented on two or more chips.

One or more of the functional blocks and/or one or more combinations of the functional blocks described with respect to the UE 206 may be embodied as a general purpose processor, a digital signal processor (DSP), an application specific integrated device, discrete gate or transistor logic, discrete hardware components, circuitry or any suitable combination thereof designed to perform the functions described herein. In this specification and the appended claims, it should be clear that the term “circuitry” is construed as a structural term and not as a functional term. For example, circuitry can be an aggregate of circuit components, such as a multiplicity of integrated circuit components, in the form of processing and/or memory cells, units, blocks, and the like, such as shown and described in FIG. 10. One or more of the functional blocks and/or one or more combinations of the functional blocks described with respect to the UE 206 may also be implemented as a combination of computing devices, e.g., a combination of a DSP and a microprocessor, a plurality of microprocessors, one or more microprocessor in conjunction with a DSP communication, or any other such configuration.

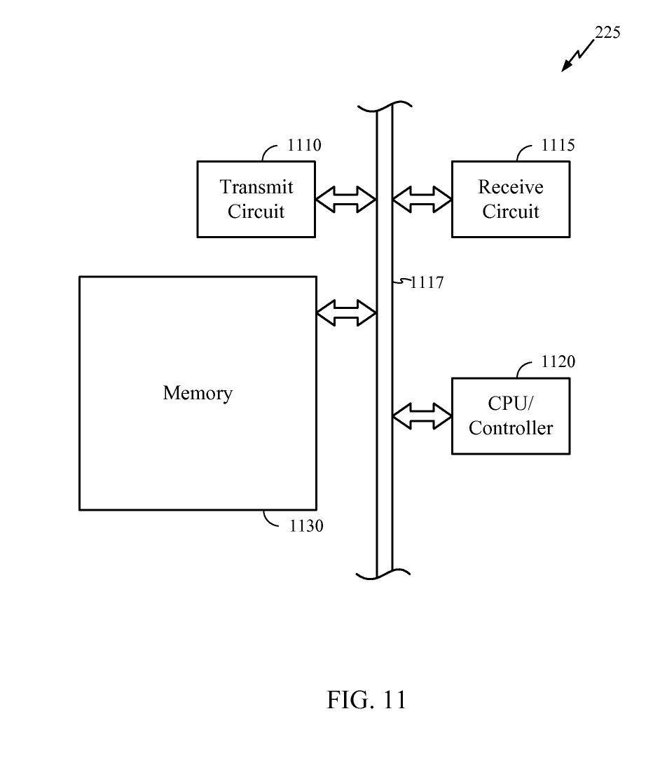

FIG. 11 is a functional block diagram of an exemplary HSGW 225 shown in FIG. 2. As discussed above with respect to FIG. 2, the HSGW 225 may communicate with the eAN 220 and the BTS 104a to send/receive data to/from the UE 206. Further, the HSGW 225 may communicate with the P-GW 227a, 227b, 227c to send/receive data to/from the application servers 202a, 202b, 202c as discussed above with respect to FIG. 2. Accordingly, the HSGW 225 may facilitate communication between the UE 206 and the application server 202a. The HSGW 225 may comprise a transmit circuit 1110 configured to transmit an outbound message, such as a request for data from the application server 202a. The HSGW 225 may further comprise a receive circuit 1115 configured to receive an incoming message, such as a data packet from the application server 202a. The transmit circuit 1110 and the receive circuit 1115 may be coupled to a central processing unit (CPU)/controller 1120 via a bus 1117. The CPU 1120 may be configured to process the inbound and outbound messages coming from or going to the application server 202a. The CPU 1120 may also be configured to control other components of the HSGW 225.

The CPU 1120 may further be coupled to a memory 1130 via the bus 1117. The CPU 1120 may read information from or write information to the memory 1130. For example, the memory 1130 may be configured to store inbound or outbound messages before, during, or after processing and/or records of connections and connection contexts. The memory 1130 may also comprise instructions or functions for execution on the CPU 120. For example, the memory 1130 may comprise instructions or functions to perform the processes and methods described herein.

The transmit circuit 1110 may comprise a modulator configured to modulate outbound messages going to the eAN 220 and/or the P-GW 227a, 227b, 227c. The receive circuit 1115 may comprise a demodulator configured to demodulate inbound messages coming from the eAN 220 and/or the P-GW 227a, 227b, 227c.

The memory 1130 may comprise processor cache, including a multi-level hierarchical cache in which different levels have different capacities and access speeds. The memory 1130 may also comprise random access memory (RAM), other volatile storage devices, or non-volatile storage devices. The storage may include hard drives, optical discs, such as compact discs (CDs) or digital video discs (DVDs), flash memory, floppy discs, magnetic tape, Zip drives, etc.

Although described separately, it is to be appreciated that functional blocks described with respect to the HSGW 225 need not be separate structural elements. For example, the CPU 1120 and the memory 1130 may be embodied on a single chip. The CPU 1120 may additionally, or in the alternative, contain memory, such as processor registers. Similarly, one or more of the functional blocks or portions of the functionality of various blocks may be embodies on a single chip. Alternatively, the functionality of a particular block may be implemented on two or more chips.

One or more of the functional blocks and/or one or more combinations of the functional blocks described with respect to the HSGW 225 may be embodied as a general purpose processor, a digital signal processor (DSP), an application specific integrated device, discrete gate or transistor logic, discrete hardware components, circuitry or any suitable combination thereof designed to perform the functions described herein. As noted above, it should be clear that the term “circuitry” is construed as a structural term and not as a functional term. For example, circuitry can be an aggregate of circuit components, such as a multiplicity of integrated circuit components, in the form of processing and/or memory cells, units, blocks, and the like, such as shown and described in FIG. 11. One or more of the functional blocks and/or one or more combinations of the functional blocks described with respect to the UE 206 may also be implemented as a combination of computing devices, e.g., a combination of a DSP and a microprocessor, a plurality of microprocessors, one or more microprocessor in conjunction with a DSP communication, or any other such configuration.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of: A, B, or C” used in the description or the claims means “A or B or C or any combination of these elements.”

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for releasing a stale connection context, the method comprising:
receiving data related to a connection context from a first device;
determining, based on reception of the data, that the connection context is stale; and
performing a resynchronization procedure with the first device.

2. The method of claim 1, wherein determining the connection context is stale comprises determining that there is no record of the connection context.

3. The method of claim 1, wherein the data is related to an application that is no longer configured to receive the data from a connection associated with the connection context.

4. The method of claim 1, wherein the connection context is associated with a terminated connection.

5. The method of claim 1, wherein the resynchronization procedure comprises a point-to-point protocol resynchronization.

6. A method for releasing a stale connection context, the method comprising:
receiving a request for a first connection context with a device;
determining there is a second connection context with the device that conflicts with the requested first connection context; and
performing a resynchronization procedure with the device.

7. The method of claim 6, further comprising determining the second connection context is a stale connection context.

8. The method of claim 7, wherein determining the second connection context is a stale connection context comprises determining the device has no record of the second connection context.

9. A communication apparatus comprising:
a receiver configured to:
receive data related to a connection context from a first device; and
a processor configured to:
determine, based on reception of the data, that the connection context is stale; and
perform a resynchronization procedure with the first device.

10. The apparatus of claim 9, wherein the processor is configured to determine the connection context is stale by determining there is no record of the connection context at the apparatus.

11. The apparatus of claim 9, wherein the data is related to an application running on the processor that is no longer configured to receive the data from a connection associated with the connection context.

12. The apparatus of claim 9, wherein the connection context is associated with a terminated connection.

13. The apparatus of claim 9, wherein the resynchronization procedure comprises a point-to-point protocol resynchronization.

14. A communication apparatus comprising:
a receiver configured to:
receive a request for a first connection context with a device; and
a processor configured to:
determine that there is a second connection context with the device that conflicts with the requested first connection context; and
perform a resynchronization procedure with the device.

15. The apparatus of claim 14, wherein the processor is further configured to determine the second connection context is a stale connection context.

16. The apparatus of claim 15, wherein the processor is configured to determine the second connection context is a stale connection context by determining the device has no record of the second connection context.

17. A computer program product comprising:
computer-readable medium comprising:
code for causing a computer to receive data related to a connection context from a first device;
code for causing a computer to determine, based on reception of the data, that the connection context is stale; and
code for causing a computer to perform a resynchronization procedure with the first device.

18. The computer program product of claim 17, wherein the computer-readable medium further comprises code for causing a computer to determine there is no record of the connection context.

19. The computer program product of claim 17, wherein the data is related to an application that is no longer configured to receive the data from a connection associated with the connection context.

20. The computer program product of claim 17, wherein the connection context is associated with a terminated connection.

21. The computer program product of claim 17, wherein the resynchronization procedure comprises a point-to-point protocol resynchronization.

22. A computer program product comprising:
computer-readable medium comprising:
code for causing a computer to receive a request for a first connection context with a device;
code for causing a computer to determine there is a second connection context with the device that conflicts with the requested first connection context; and
code for causing a computer to perform a resynchronization procedure with the device.

23. The computer program product of claim 22, wherein the computer-readable medium further comprises code for causing a computer to determine the second connection context is a stale connection context.

24. The computer program product of claim 23, wherein the computer-readable medium further comprises code for causing a computer to determine the device has no record of the second connection context.

25. A communication apparatus comprising:
means for receiving data related to a connection context from a first device;
means for determining, based on reception of the data, that the connection context is stale; and
means for performing a resynchronization procedure with the first device.

26. A communication apparatus comprising:
means for receiving a request for a first connection context with a device;
means for determining there is a second connection context with the device that conflicts with the requested first connection context; and
means for performing a resynchronization procedure with the device.
